(19) United States
(12) Patent Application Publication
(10) Pub. No.: US 2026/0258517 A1
(43) Pub. Date: Sep. 3, 2026

(54) COMPOSITION OF CHARCOAL FOR USE IN PRODUCTION OF STEEL, PROCESS OF FOAMING SLAG IN THE PRODUCTION OF STEEL IN ELECTRIC ARC FURNACES AND USE OF A COMPOSITION OF CHARCOAL

(71) Applicant: VALLOUREC SOLUÇÕES TUBULARES DO BRASIL S.A, Belo Horizonte - MG (BR)

(72) Inventors: Claudio MUSSO VELLOSO, Jeceaba - MG (BR); Domingos Fábio DE CARVALHO, Jeceaba - MG (BR); Sávia Cristina LACERDA POUBEL PINHEIRO, Jeceaba - MG (BR)

(73) Assignee: VALLOUREC SOLUÇÕES TUBULARES DO BRASIL S.A, Belo Horizonte - MG (BR)

(21) Appl. No.: 18/878,710

(22) PCT Filed: Jun. 28, 2023
(86) PCT No.: PCT/BR2023/050217

§ 371 Date: Dec. 24, 2024

(30) Foreign Application Priority Data
Jun. 30, 2022 (BR) 1020220131058

(51) Int. Cl. C21C 5/54

(52) U.S. Cl. CPC C21C 5/54; C21C 2250/00

(57) ABSTRACT

A composition of charcoal for use in steel production includes between 60 and 90% by weight of fixed carbon, between 13 and 25% by weight of volatile materials and between 0.5 and 5% by weight of ash. At least 98% by volume of the composition possesses a granulometry less than or equal to 4 millimeters.

The present invention relates to a composition of charcoal to be used as substitute for coke in a process of foaming slag in the production of steel in electric arc furnaces.

### DESCRIPTION OF THE STATE OF THE ART

The processes of production of steel in an electric arc furnace are widely known in the state of the art. The iron scrap, as raw material, together with solid pig iron and/or liquid pig iron, is processed in the first stage (primary metallurgy) and, subsequently, the temperature and the chemical composition is adjusted for solidification of the steel in such manner as to produce iron and steel products having application in the fields of petroleum and gas, civil and automotive construction among others. One of the essential stages in primary metallurgy in an electric steelworks is the foaming of the slag by means of injection of carbonaceous material, there commonly being utilised green petroleum coke, calcined coke and graphite (fossil fuels). Currently, approximately 12 kg of coke is utilised per tonne of liquid steel. The foaming of the slag is fundamental, by virtue of the fact that it confers a layer of insulation and protection, preventing the refractories from suffering by virtue of the extreme heat radiation from the electric arc and, furthermore, ensuring the thermal efficiency in relation to the transfer of energy from the arc to the metal bath.

Nevertheless, using a large quantity of carbonaceous materials of fossil origin, such as coke, a large quantity of derived carbon dioxide gas, that is to say, greenhouse gases, is emitted to the atmosphere. Between 40 and 70% of the emission of CO₂ from the process of production of steel in the electric furnace arises from the stage of injection of carbon for foaming the slag. The process is, consequently, a significant generator of environmental impact to be mitigated or prevented. Furthermore, the utilisation of coke involves sources of input of sulphur and phosphorus into the process of production of the steel, these for the most part being undesirable.

By virtue of these problems alternatives are sought to substitute the use of coke during the stage of foaming of the slag. The document CN101558170 reveals a process of manufacture of steel in an electric arc furnace including the stages of feeding a mixture obtained by means of the addition of carbide, obtained through dry distillation of coconut palm or oil palm coconut shells (palm kernel shell charcoal or PKS charcoal), and having a content of residual volatile materials of 12% or more, to iron scrap, and production of liquid steel through the melting of the iron scrap. According to this document it is preferable that this material injected into the electric arc furnace, by means of a lance, have a residual content of volatile materials lower than 12%.

The substitute for coke employed in this document presents a high carbon content and maximum content of volatile materials of 12% for application of the material by lance. The restriction on the content of volatile materials is in order to ensure the satisfactory injection of the source of carbon penetrating the slag to continue with the foaming thereof, by virtue of the fact that the higher content of volatile materials associated with the low density, compared to coke, does not ensure the efficiency of such process. A further point addressed in relation to this substitute for coke is the small scale of production thereof and the greater cost of production thereof, in this manner impeding the continued utilisation thereof, it being further accentuated as a result of the restriction on the content of volatile materials.

### OBJECTIVES OF THE INVENTION

The present invention has as objective the provision of an alternative to the coke utilised in the production of steel in electric furnaces which is less harmful to the environment by means of a charcoal suitable to be used in the stage of foaming of the slag.

### BRIEF DESCRIPTION OF THE INVENTION

The objectives of the invention are achieved by means of a process of foaming of slag in the production of steel in electric arc furnaces, injecting the charcoal onto the surface in order to foam the slag.

The charcoal injected during the production is a composition of charcoal for use in steel production containing between 60 and 90% by weight of fixed carbon, between 13 and 25% by weight of volatile materials and between 0.5 and 5% by weight of ash.

In a preferential composition, the charcoal utilised comprises a range between 70 and 85% by weight of fixed carbon, between 13 and 23.5% by weight of volatile materials and between 0.5 and 3% by weight of ash. In a preferential manner, the granulometry of the charcoal utilised was 100% less than 4 millimetres, said range having been identified during the tests carried out such that obstruction of the injection line does not occur.

### BRIEF DESCRIPTION OF THE FIGURES

For better comprehension, the characteristics and advantages of the present invention will be presented and described in conjunction with the respective FIGURES thereof, they illustrating:

FIG. 1 illustrates a schematic design of an electric arc furnace.

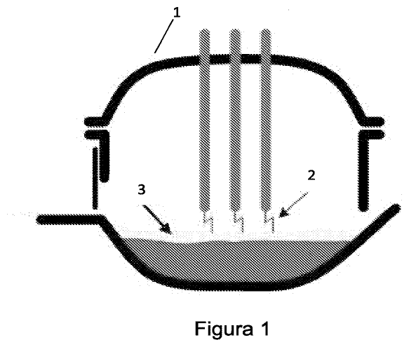

### DETAILED DESCRIPTION OF THE INVENTION

The composition of charcoal, object of the present invention, is utilised in a process of production of steel in electric arc furnaces 1, wherein the scrap is utilised as principal raw material, it also being possible to utilise solid pig iron and/or liquid pig iron, for steel production.

As the melting of the raw material occurs, the height of the same decreases within the furnace such that the electric arc 2 radiates heat to the lateral walls and arch of the furnace, they being lined with refractory bricks. The excess radiated heat is extremely damaging to the surface of the refractory bricks and may lead to an accelerated degradation of the same, greatly raising the cost of maintenance of the electric furnaces. This radiated heat also represents a considerable energy loss during the process, because heat that could be used to assist in the melting of the raw material is dispersed into the environment.

The formation of the foaming slag 3 is an important stage at this point, by virtue of the fact that it forms a layer of protection surrounding the electric arc 2, retaining a great quantity of the energy which would be dissipated to the environment, directing it subsequently to the liquid steel, consequently resulting in greater energy efficiency and increasing the durability of the refractory lining. The foaming of the slag 3 presents an additional advantage of reducing the current and voltage fluctuation, in addition to the acoustic noise. However this practice leads to a great quantity of CO (carbon monoxide) gas being produced.

For the formation of the foaming slag 3 there is required: (i) availability of carbon and oxygen for the reactions of formation of CO, (ii) increase in the viscosity of the slag and (iii) basicity of the slag greater than 2.5. Normally, the source of carbon utilised in this foaming process has been coke, it being a fossil fuel and incorporates sulphur and phosphorus into the steel. Such elements are undesirable in the majority of the applications of steels by virtue of the fact that they involve a reduction in the ductility, toughness and weldability of the materials.

The composition of charcoal according to the present invention serves as substitute for coke in this process of foaming of the slag. The aforementioned charcoal possesses between 60 and 90% by weight of fixed carbon, between 13 and 25% by weight of volatile materials and between 0.5 and 5% by weight of ash. Ash is an intrinsic contaminant material in the process, having a minimum content of 0.5%. The volatile materials, as a result of the production process of the charcoal, have a minimum content of 13%, the production thereof having lower values being improbable. Furthermore, at least 98% by volume of the composition possesses a granulometry less than or equal to 4 millimetres.

Both the specified composition and the specified granulometry are fundamental for the functioning of the process according to the present invention. In tests carried out it was observed that the granulometry of the charcoal is a critical point in order to prevent blockages of the injection line. Five tests of injection were carried out, wherein the first two were carried out without granulometry control and there was blockage of the injection lines. During analysis of the occurrences of the blockages the presence was observed of large pieces of charcoal and the necessity of granulometry control was identified. Once having defined the ideal range of granulometry as being at least 98% less than or equal to 4 millimetres, the subsequent tests took place without blockage events. Table 1 below shows the progression in the refinement of the granulometry:

TABLE 1

| | Granulometry (% passing) | | |
|---|---|---|---|
| Test | ≤4 | >4 | Test result |
| 3 | 98-100 | 0-2 | Without obstruction |
| 4 | 99-100 | 0-1 | in the injection line |
| 5 | 99-100 | 0-1 | |

In relation to the chemical composition, the same was initially planned with the objective of high fixed carbon. Based upon results from the first two tests, the necessity was demonstrated of controlling the volatile materials and ash such as to ensure that the material is suitably injected, reaching the slag as a source of carbon without entering into combustion on initiating the injection of the same, this being realised by means of a supersonic lance.

The refinement of the chemical composition of charcoal tested in the 5 tests is shown in Table 2 below:

TABLE 2

| | Chemical composition range (%) | | | |
|---|---|---|---|---|
| | Fixed | | Volatile | |
| Test | carbon | Ash | materials | Test result |
| 1 | 75-85 | 0.5-3 | 13-18 | Satisfactory injection |
| | | | | in one run |
| 2 | 75-85 | 0.5-3 | 13-18 | Satisfactory injection |
| | | | | in three runs, however |
| | | | | there was occurrence |
| | | | | of obstruction in the |
| | | | | injection line |
| 3 | 70-85 | 0.5-1.5 | 13-25 | Satisfactory injection |
| | | | | in five runs, without |
| | | | | occurrence of |
| | | | | obstruction in the |
| | | | | injection line by virtue |
| | | | | of the granulometry |
| | | | | specification drawn up |
| 4 | 65-85 | 0.5-1.5 | 13-23.5 | Satisfactory injection |
| | | | | in thirty-five runs, |
| | | | | without occurrence |
| | | | | of obstruction |
| | | | | in the injection line |
| 5 | 70-85 | 0.5-1.5 | 13-23.5 | Satisfactory injection |
| | | | | in thirty runs, |
| | | | | without occurrence |
| | | | | of obstruction |
| | | | | in the injection line |

The tests carried out permitted the development of a general composition of the charcoal, comprising a broad range from 60% to 90% of fixed carbon, including plus or minus 5% in relation to the maximum limits tested by virtue of the intrinsic variability of the production process of the charcoal. The volatile materials are comprised in the broad range from 13% to 25% and the ash in the range between 0.5% and 5%. The broadest granulometry of the composition is 98% by volume less or equal to 4 mm.

From among the tests carried out, the satisfactory results comprised a preferential charcoal composition in a range between 70 and 85% by weight of fixed carbon, between 13 and 23.5% by weight of volatile materials and between 0.5 and 3% by weight of ash. The satisfactory granulometry of the composition is 99% by volume less than or equal to 4 mm.

Finally, the best results obtained in the development permit the definition of an even more preferential composition of charcoal in the range from 70 to 85% of fixed carbon, from 13 to 18% of volatile materials and ash between 0.5% and 1.5%. In this preferential composition, 100% by volume of the composition possesses a granulometry less than or equal to 4 millimetres. The combination of these defined limits of carbon, volatiles, ash and granulometry in the preferential composition permits the obtainment of the best results in the development of the tests carried out.

The use of charcoal in the production of steel is particularly advantageous when compared with carbonaceous materials composed of fossil fuels, such as coke, by virtue of the fact that the emissions of greenhouse gases are theoretically considered neutral or neutralised. The carbon dioxide produced from biomass fuel is considered to be “neutral carbon” or “biogenic carbon” and is not included within the category of greenhouse gases, by virtue of the fact that the emission thereof is neutralised by the reafforestation employed in the production of charcoal. Furthermore, the contents of sulphur and phosphorus are lower when compared to coke, this being an additional advantage by virtue of the fact that these elements must be lowered in this first stage of process of production of steel.

The description set out above illustrates preferable embodiments of the present invention, nevertheless the scope hereof is not limited by the examples set out nor by the FIGURES accompanying the application. The person skilled in the art will perceive that diverse other configurations are perfectly possible.

1. A composition of charcoal for use in steel production, comprising:
between 60 and 90% by weight of fixed carbon,
between 13 and 25% by weight of volatile materials,
between 0.5 and 5% by weight of ash,
wherein at least 98% by volume of the composition possesses granulometry of less than or equal to 4 millimetres.

2. The composition according to claim 1, comprising:
between 70 and 85% by weight of fixed carbon,
between 13 and 23.5% by weight of volatile materials,
between 0.5 and 3% by weight of ash,
wherein at least 99% by volume of the composition possesses granulometry of less than or equal to 4 millimetres.

3. The composition according to claim 1, comprising:
between 70 and 85% by weight of fixed carbon,
between 13 and 18% by weight of volatile materials,
between 0.5 and 1.5% by weight of ash,
wherein the granulometry of the composition is less than or equal to 4 millimetres.

4. A process of foaming slag in the production of steel in electric arc furnaces, comprising injecting a composition of charcoal according to claim 1 upon the surface of the slag to foam the slag.

5. A use of a composition of charcoal as defined in claim 1 in steel production.
